(19) United States
(12) Patent Application Publication
(10) Pub. No.: US 2022/0358461 A1
(43) Pub. Date: Nov. 10, 2022

(54) CONTINUOUS MANAGEMENT OF TEAM CONTENT AND RESOURCES

(71) Applicant: SAP SE, Walldorf (DE)

(72) Inventor: Divya Tiwari, Weisloch (DE)

(21) Appl. No.: 17/313,268

(22) Filed: May 6, 2021

(51) Int. Cl. G06Q 10/10; G06F 21/62; H04L 12/58; G06N 20/00

(52) U.S. Cl. CPC G06Q 10/103; G06F 21/6209; H04L 51/02; H04L 51/046; G06N 20/00

(57) ABSTRACT

The present disclosure involves systems, software, and computer implemented methods for continuous management of team networks and resources. One example method includes receiving, at a team continuity platform that manages team-specific content for multiple teams of an organization, a request to manage team content for a team. A team content repository is created for the team. Team members and team-specific content are added at the team continuity platform. A request is received from a user for a team content item. A determination is made as to whether the user is authorized to access the team content item. In response to determining that the user is authorized to access the team content item, access is provided to the team content item to the user. In response to determining that the user is not authorized to access the team content item, access to the team content item is denied for the user.

### TECHNICAL FIELD

The present disclosure relates to computer-implemented methods, software, and systems for continuous management of team content and resources.

### BACKGROUND

A corporate entity generally has different departments for supporting the operations of the entity. For example, a human resources department can perform various operations related to acquiring and supporting employees of the entity. As another example, an information technology (IT) department can perform various support operations for supporting use of technology within the entity. Both the human resources department and the IT department can provide software applications that employees of the entity can use to access different services offered by the respective departments.

### SUMMARY

The present disclosure involves systems, software, and computer implemented methods for continuous management of team content and resources. An example method includes: receiving, at a team continuity platform that manages team-specific content for multiple teams of an organization, a request to manage team content for a first team; creating a team content repository for the first team at the team continuity platform; adding multiple team members to the first team at the team continuity platform in response to receiving multiple respective add team member requests; adding at least one team-specific content item for the first team at the team continuity platform in response to receiving at least one add team content request; receiving, from a user, a first request for a first team content item for the first team; determining whether the user is authorized to access the first team content item; in response to determining that the user is authorized to access the first team content item, providing access to the first team content item to the user; and in response to determining that the user is not authorized to access the first team content item, denying access to the first team content item for the user.

Implementations can include one or more of the following features. Determining that the user is authorized to access the first team content item can include determining that the user is a member of the first team who has sufficient privileges to access the first team content item. The first team content item can be contact information for a non-team employee who interacts with the first team. The first team content item can be a document used by the first team. The document can be stored at an organizational system that is separate from the team continuity platform. The team continuity platform can maintain a copy of the document at the team continuity platform and provide the copy of the document in response to the first request. The team continuity platform can retrieve the document from the organizational system in response to the first request. A team content update process can be initiated that is configured to automatically monitor team content status at the organizational system for the first team and automatically retrieve updated team content from the organizational system in response to determining that team content for the first team is out of date. The team content update process can include: automatically detecting that the copy of the document stored at the team continuity platform is an older version of the document than a version of the document that is stored at the organizational system; and automatically retrieving the version of the document stored at the organizational system to update the copy of the document stored at the team continuity platform. The first team content item can be a link to the document stored at the organizational system. An instance of a virtual team assistant can be created to handle requests for the first team. The team assistant can receive the first request for the first team content item. The user can interact with the virtual team assistant using a conversational interface. The user can provide feedback for handling of the first request to the virtual team assistant and a machine learning component of the virtual team assistant can update a machine learning model to improve handling of future team content requests for the first team. A description of a team process to be performed by members of the first team can be received at the team continuity platform. A request to execute the team process can be received for a first member of the first team. The virtual team assistant can guide the first member of the first team to execute steps of the first process.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for continuous management of team content and resources.

FIG. 2 illustrates example team chatbot user interfaces.

FIG. 3 illustrates embedded team chatbots.

FIG. 4 is a flowchart of an example method for continuous management of team content and resources.

### DETAILED DESCRIPTION

Teams within an organization have various processes, documents, tools, equipment, and contact lists that are specific to the team. Team-related information and resources can be managed by manual processes, which require time and effort and may not always be performed on an adequate basis, which can lead to team content or resources becoming outdated, inconsistent, or invalid. Additionally, some team members may store or link to team information using personal documents or repositories, which are not shared. Particular problems can occur when a team member leaves and team-specific knowledge or content acquired or managed by the departing team member is no longer available. Specific areas where manual approaches are not efficient for managing team content include a team contact network, team content searching and access, and common team processes.

For example, members of a team may interface with particular members of other teams or departments within an organization, where one example of team knowledge is a team contact network, which can be referred to as a team friend list. With manual efforts, each team member may maintain separate information that represents a network of contacts for the team. The team may lack a central repository for storing and managing a structured, central resource of team contacts. When a person leaves the team, the team may no longer have access to a network of team contacts that the departing team member had built and maintained while on the team, forcing each new addition to the team therefore may have to re-establish a network of team contacts.

As another example, with manual approaches team members may perform same or similar repetitive searches for other team-related content, such as links, documentation, tools, etc. Each team member may have to experiment to determine which searches are most effective for retrieving team information or content, and such experimentation and effort may be repeated by each team member or even by a same team member over time. A common document can be used, but each team member still may have to perform additional steps to search or navigate within the common document to find desired information.

Teams may also have manual processes that are common to the team, such as team-specific onboarding that includes different steps and procedures from organizational-level employee onboarding. As another example, a team may have manual processes for development environment setup which go beyond a basic information technology setup for a new employee. Teams may document these manual processes in documents used by the team, but a team member may have to manually read the document to perform the steps, and the steps in the document can quickly and easily become out of date, resulting in maintenance and accuracy issues.

To solve various problems of managing information for a team, a team continuity platform can be used. The team continuity platform can manage information for multiple teams within an organization, and can integrate each team, allowing information to be shared within the team on the fly and capturing team information for the long term, such as for sharing with future team members. Members of a team may leave or be replaced over time, for example. When an employee leaves the team or the company, the information critical to team functionality is retained and continues to be made accessible by the platform. The platform can provide a long term solution of team intelligence that can be leveraged by the team even when team members who initially configure or share team content are no longer on the team.

For example, in an onboarding scenario, when a new team member joins the team, the team member can easily obtain information necessary for team-specific onboarding, such as required documents, a list of people (e.g., within and/or outside the team) that the team member may need to interact with as a member of the team, and other information useful for performing job duties as a team member. The new addition to the team can quickly access team information without struggling with knowing how to find needed information or having to repeatedly ask other team members for help. Accordingly, new hire ramp-up time can be significantly reduced and the team member can become a productive member of the team more quickly as compared to prior manual approaches for managing information.

The team continuity platform can be used to capture, manage, and provide vital information relevant to a team, including information and content helpful for performing various tasks of the team. The platform can be used as a framework that can manage current team content and also support additional team content or activities in the future. Through use of the platform, team members can be kept up to date with team-relevant tools, systems and documentation searches and can quickly access team content. Additionally, repetitive and counterproductive searches for team content can be avoided. The benefits of the platform, when realized by a team, can provide team employees with an engaging, rewarding, and productive work experience.

The platform can capture and manages various types of team information of use to the team, over time, for use in various types of scenarios. For example, the platform can manage a team friend list, team-related quick-links, a team tools and content repository, and team equipment inventory. Additionally, the platform can be used to define, manage, and execute guided team processes, such as team onboarding, development environment setup, or other processes that may be defined, for example, by a team manager or other team member.

Team members can obtain information from the system using a variety of approaches. For example, the platform can be accessed using a platform application or dashboard. As another example, platform features can be used as add-on features that are integrated into existing applications, organizational database, or knowledge bases. As an example of platform access, a team member can use a team chat bot (“chatbot”) that is included in a platform application or other application. While existing chatbots may provide technical support at an organizational level, the existing solutions are not structured to provide team-level information sharing for sharing information across members of a team. The team chatbot provided by the platform can be queried and provide requested information, such as by using AI (Artificial Intelligence) or other approaches.

For example, the team chatbot can use conversational AI and machine learning to enable access to current, up to date information. For example, a team member can use the team chatbot to both query for information and to provide new or updated information to be managed for the team by the platform. As another example, the platform can, behind the scenes, automatically perform content update processes to keep team content up to date. The team chatbot can enable team member feedback on provided results, and a learning engine included in the platform can update a machine learning model so that search results and content retrieval is improved for team members over time.

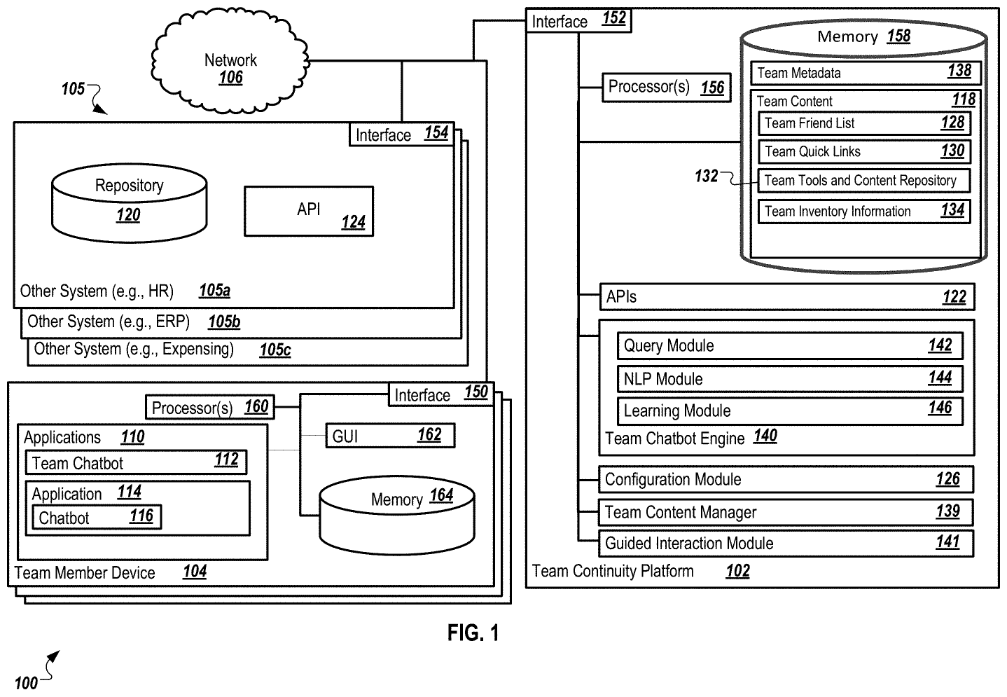

FIG. 1 is a block diagram illustrating an example system 100 for continuous management of team content and resources. Specifically, the illustrated system 100 includes or is communicably coupled with a team continuity platform 102, a team member device 104, one or more other systems 105 including other systems 105a, 105b, and 105c, and a network 106. Although shown separately, in some implementations, functionality of two or more systems or servers may be provided by a single system or server. In some implementations, the functionality of one illustrated system, server, or component may be provided by multiple systems, servers, or components, respectively. For example, the team continuity platform 102 may include different engines which may be provided by multiple systems or servers.

Each team member of a team can use at least one team member device 104. The team member device 104 can include various applications 110. The applications 110 can include a team chatbot 112 that the team member can use to access the team continuity platform 102. As another example, the team member device 104 can include other applications, including an application 114. Some applications 110 can be used to access one or more of the other systems 105. Some applications 110, such as the application 114, can be integrated with an embedded team chatbot 116, and the team member can use the embedded team chatbot 116 to access the team continuity platform 102.

The team continuity platform 102 can store team content at the team continuity platform 102 platform in a team content repository 118 and can manage and provide access to team content that is stored in other systems, such as a repository 120 of the other system 105a. The team continuity platform 102 can access the other systems 105 using different APIs (Application Programming Interfaces) 122 (and/or using API(s) of the other systems 105, such as an API 124 provided by the other system 105a). The other systems 105 can include various types of organizational systems. For example, the other systems 105a, 105b, and 105c can be an HR system, an ERP (Enterprise Resource Planning) system, and an expensing system. The team continuity platform can be managed within the organization separately from the other systems 105.

The team continuity platform 102 can serve as a layer between the existing other systems 105 and the team members of the team. As described in more detail below, the team continuity platform 102 can connect to the other systems 105 on behalf of a team member. The team continuity platform 102 can ensure that a team member is provided current information and can enable team members to manage team content. For example, a team manager or another team member can initially identify and/or create team content using a team configuration module 126, and the team continuity platform 102 can manage the team content, even when the team content is stored in or is linked to information in the other systems 105. When handling requests for team content, the team continuity platform 102 can pull information from different content resources, including the team content repository 118 and the other systems 105.

Team content can include information, documents, links to information or documents, resources or links to resources, or other team data or information. For example, team content can include a team friend list 128, team quick links 130, a team tools and content repository 132, and team inventory information 134.

The team friend list 128 is a user group that includes persons and contacts that a team has day-to-day interaction with in order to do their work. For example, a software company may have a customer adoption team that assists customers with installation of the software product. Members of the customer adoption team may communicate with different engineering teams to stay abreast of upcoming features and availability dates of the upcoming features. Accordingly, the customer adoption team may interface with various product managers on various engineering teams. The team continuity platform 102 can be used to manage inclusion of the various engineering product managers as members of the team friend list 128. For example, a first customer adoption team member can add an engineering product manager for a certain software feature to the team friend list 128 and a second customer adoption team member, such as an employee new to the team, can easily query the team continuity platform 102 for the product manager for the software feature without having to navigate other systems or directories to find the right person or right contact information, even if the first team member has subsequently left the team.

In general, the team friend list 128 is a network of people to which team members interface. Managing the team friend list 128 at the team continuity platform 102 allows for retention of the network of team contacts included in the team friend list 128 even as team members fluctuate. Each current member of the team can access the team friend list 128.

Team members can add or modify contacts in the team friend list 128. In some cases, any team member can add or modify a contact in the team friend list 128. In other cases, certain team members (e.g., members approved by a team manager) can change the team friend list 128. As another example, an approver can approve modifications by team members to the team friend list 128. In some implementations, the team friend list 128 includes members of the team itself. In other cases, the team friend list 128 only includes non-team members to which the team interfaces, and team members can be managed separately, such as in team metadata 138. In some cases, the team friend list is automatically maintained, and/or suggestions for additions are automatically generated, in response to the system detecting that team members interact with other employees frequently, for example.

In some implementations, some or all contacts in the team friend list have one or more tags that can be used for categorization and retrieval of contacts in the team friend list 128. For example, some or all contacts in the team friend list 128 can be tagged with a team-relevant role name when being added to the team friend list 128 by a team member. Tags can be monitored and controlled by an administrator who can be the team manager, a team lead, or some other authorized team member. Tags can also be added or modified after a contact is added to the team friend list 128. Tags for contacts in the team friend list 128 can be used to index entries in the team friend list 128 and to retrieve matching entries in response to a query of the team friend list 128 by a team member. In some cases, tags can be automatically associated with a team member, such as by retrieving a job title from an external system and using the job title when automatically creating a tag for the team member.

As another example, information in the team friend list 128 can be integrated with or link to information in another system, such as a HR system or an organization chart system or resource. For instance, with respect to the above example of the customer adoption team needing to access the product manager of the engineering team, the team friend list 128 can include a dynamic link to an organizational chart resource that can be used dynamically to access contact information for the current product manager of the engineering team.

The team quick links 130 can include links to various team resources or systems used by the team. To name a few examples, the team quick links 130 can include links to a team collaboration system used by the team, links to mailing distribution lists used by the team, or links to team folders (which can be links to network resources or links to folders in applications of one or more of the other systems 105). The team quick links 130 can include links to resources used during onboarding and/or resources used by the team in day to day team activities. As with the team friend list 128, the team quick links 130 can be maintained by members of the team. The team quick links 130 can include links to external documents or resources or to a document or resource managed by the team continuity platform 102, such as a document or resource in the team tools and content repository 132.

The team tools and content repository 132 can be used to provide access, for example, to team documents and development or other software tools used by the team. As with the team friend list 128 and the team quick links 130, the team tools and content repository 132 can be maintained by members of the team.

The team inventory information 134 can include information, for example, about team hardware inventory and assignments. Particular members of the team may have checked out an item of team equipment, such as a laptop, mobile device for testing, or some other type of equipment. In some cases, team members can use the team continuity platform 102 to interface with a separate inventory management tool (e.g., that may be one of the other systems 105). As another example, team inventory management can be implemented within the team continuity platform 102.

Initial setup of a team within the team continuity platform 102 can be performed using the team configuration module 126. For example, a team manager can add each current team member to the team. The team manager can use the team chatbot 112 or the embedded team chatbot 116 to interface with the team configuration module 126, for example. Team member information can be stored in the team metadata 138. Initial team quick links 130, an initial team friend list 128, initial team inventory information 134, and initial content in the team tools and content repository 132 can be configured. In some cases, the team manager, a team lead, or another team member who is configuring the team can decide whether certain resources are maintained locally in the team content repository 118, or whether a team quick link 130 to an external resource is used. Deciding whether local content, a local copy, or external content is to be used can depend on a number of factors, such as access speed, access reliability (e.g., is an external system generally accessible or are there sometimes connection issues?), content size, and other factors. Manual decisions can be made as to a location of content.

As another example, a team content manager 139 can automatically make decisions regarding content location on behalf of the team. The team content manager 139 can be used to manage content location, content access, and content updates. The team content manager 139 can automatically make a decision regarding content location of a team content item, either as an initial decision or a periodic decision, based on a number of factors, such as content access frequency, access speed, access reliability, content security, content size, etc. For example, a team resource may initially be accessed from one of the other systems 105, but the team content manager 139 may automatically determine to store the content in the team content repository 118, either as local content or a local copy, in response to determining that average response time from the other system 105 is less than a threshold, an access frequency is more than a threshold, team conversational feedback has been detected about slow or unavailable access, or other relevant factors.

When the resource is stored as a local cached copy, the team content manager 139 can automatically perform content updates to keep the local cached copy of the resource up to date. For example, the team content manager 139 can poll the other system 105 that is the source of the resource or can be notified when the resource has been updated at the other system 105. The team content manager 139 can perform other content update operations. For example, some team content may be feed-based, and the team content manager 139 can automatically receive feed updates and make the received feed information available in the team continuity platform 102 for team members. As another example, the team content manager 139 can automatically and periodically check to determine whether new versions of any team tools are available.

In general, once team content (e.g., a new addition to a team friend list) has been added, the team continuity platform 102 can automatically manage the team content to keep the team content up to date. For instance, with respect to the above example of the customer adoption team interfacing with the engineering team, the product manager of the engineering team may leave his or her position and accordingly, without further intervention, the team friend list 128 may be out of date with respect to the product manager. The team content manager 139 can automatically determine that the product manager employee who is included in the team friend list 128 no longer holds the same position. For example, the team content manager 139 can periodically query a HR system (e.g., the other system 105a), a contact list system, an organizational chart system, or some other system to determine the position change and to also identify a replacement employee who now holds the same position. The replacement employee can be automatically added to the team friend list 128 as a replacement for the employee who left the product manager position. A team member who subsequently queries the team continuity platform 102 for the product manager can automatically get information for the new replacement employee, without having to do further searching in other systems, even if the team member is unaware of the product manager employee change.

The team content manager 139 can manage different aspects of content access. For example, the team content manager 139 can manage credentials for team-based accounts that may be used to access various systems. Team credentials can be stored in the team metadata 138, for example. The team content manager 139 can access the other systems 105, using the APIs 122 and the stored team credentials, as needed. The team content manager 139 can connect to and retrieve content for the team, from both internal and external systems and/or websites.

After the team and team content have been configured, team members can interface with the team continuity platform 102 using the team chatbot 112 (or the embedded team chatbot 116), as well as through other means, such as a web browser or related application. The team chatbot 112 and the embedded team chatbot 116 can be client-side versions of a server-side team chatbot engine 140. The team chatbot engine 140, along with a guided interaction module 141, can enable team members to perform defined team-based processes, such as checking in or checking out an item of team equipment. As described in more detail below, the team chatbot engine 140 can also provide notifications, such as expiration of a checkout period of a checked-out item of equipment, or other notifications related to team resources. Guided processes and querying using the team chatbot engine 140 are described in more detail below.

In general, the team chatbot engine 140 can provide (e.g., through the team chatbot 112 and the embedded team chatbot 116), a virtual team assistant that is always available to provide and manage information relevant to the team. The team continuity platform 102 can provide team-based management for multiple teams within an organization (and for multiple organizations). In some implementations, a different team chatbot engine 140 instance is used for different teams (or in some cases, for different organizations). In other implementations, a same team chatbot engine 140 can manage multiple teams, for a same organization or different organizations. The team chatbot engine 140 can authenticate each request to make sure a user making a request has appropriate permissions to access particular team resources.

Providing the embedded team chatbot 116 enables access to the team chatbot engine 140 from a variety of applications, such as other team management applications, discussion groups, other collaborative environments, or other types of workgroup applications. The embedded team chatbot 116 can be a widget that can be easily integrated with another application. As another example, the embedded team chatbot 116 can be an “on-top” window that can be configured to float on top of other applications on a user's desktop. The embedded team chatbot 116 can also be voice-operated, and can run in the background, listening for requests, on various types of devices, including mobile devices. In some cases, the embedded team chatbot 116 can be integrated with existing voice command platforms that a user may use on a mobile device or other computing device, for example.

The embedded team chatbot 116 (and the separate application team chatbot 112) can enable querying the team continuity platform 102 and receiving notifications from the team continuity platform 102 (such as notifications regarding inventory management, as mentioned, notifications about upcoming team-related events, etc.) Some team-level information, such as team events, may be stored and managed as part of the team metadata 138, or may be stored as team content in the team content repository 118.

Team members can use the team chatbot 112 or the embedded team chatbot 116 to send various types of queries to the team continuity platform 102. For example, a team member can query for a given team quick link 130, or for a document or tool (or tool information) in the tools and content repository 132. As another example, the team member can perform queries related to the team inventory information 134. For instance, a team member can query as to where a piece of equipment might be, who has the equipment checked out, when the equipment may be available, etc. The team friend list 128 can be queried for particular types of team contacts, even as organizational personnel fluctuates or people change positions. For instance and as mentioned above, a customer adoption team member may use the team chatbot 112 to query for a particular software feature product manager. A query module 142 can receive team queries, process the queries to determine how and where to obtain requested information (e.g., from the team content repository 118 or one or more other systems 1105), retrieve the requested information, and provide the requested information (e.g., to a requesting team member device 104, which can include presenting a query response in the team chatbot 112 or the embedded team chatbot 116).

Some query processing may involve a retrieval of a document, a resource, or other information from a configured location. Other query processing may involve AI and more complex processing, including accessing different types of other systems 105 or services. For instance, the query module 142 can provide contact information for the requested software team product manager requested by the customer adoption team member. As another example, the team chatbot engine 140 can assist the team member with contacting the product manager (e.g., by automating at least part of an electronic communication to be sent to the product manager), and/or can further assist the team member if a first attempt at contacting the product manager is unsuccessful.

The team member can use conversational AI to interact with the team chatbot engine 140. For instance, the team chatbot engine can include a NLP (Natural Language Processing) module 144 that can enable the team member to use conversational dialogue with the team chatbot engine 140 (e.g., through the team chatbot 112 and/or the embedded team chatbot 116). For instance, the team member can inform the team chatbot engine 140 that a first attempt at contacting the product manager was unsuccessful. The query module 142 can determine other suggestions for fulfilling the initial team member request, such as offering contact information for a manager of the product manager, determining that the product manager position has been recently vacated (and refilled), suggesting links to an organizational chart application or a specific object in the organizational chart, etc. Suggestions determined by the query module 142 can be provided to the team member, for example, as query and/or dialogue responses.

In general, the query module 142 can determine whether requested information exists in the team content repository 118 or whether requested information can be retrieved from one of the other systems 105. For example, team members can use the team continuity platform 102 for travel-based queries and requests. Some information related to team travel, such as budgets available for travel, might exist in an organization-wide expensing system 105c. Other information may be able to be obtained from an external resource, such as a travel site. The team members can use the team continuity platform 102 as a single interface, and team-related information can be used by the query module 142 when formulating a response to a query. For example, the query module 142 can determine which candidate flights might match team budgets or team travel parameters.

The query module 142 can process queries based on query type (e.g., type of requested information), query context, and requester roles and permissions. For example, the query module 142 can automatically identify and/or know a team context for a particular request, based on a team of a requester. The requester need not specify which team they are in. The query module 142 can be configured to interpret requests as team-specific requests, for the team associated with the team member that submitted a query. For example, some teams may have approved travel budgets, and the query module can know to process, interpret, and/or forward travel requests to appropriate travel systems, for members of teams who are approved to travel. For a team for which travel is not relevant or approved, the query module 142 can respond with a simple response indicating travel is not approved. As another example, a particular module, such as a travel-based module, may be omitted from team chatbot engine instances that serve teams who do not travel for business.

The query module 142 may determine that some queries received at the team chatbot engine 140 are actually not team-specific and can be fulfilled by connecting to an enterprise-wide system 105. For instance, a user may ask for a copy of their latest pay stub and the query module 142 can forward a request to an internal accounting system. The team member can therefore use a same conversational interface, for both standard and team-specific queries, for example. The query module 142 can determine whether a given query is team-specific. Responses from the query module 142 can vary based on roles or permissions of the requester. For instance, a sales force manager may have access to sales data for all regions handled by a team, but a given sales person may only have access to data for an assigned region. The system can provide data to which a given team member has access, as appropriate.

The team chatbot engine 140 can include a learning module 146 that can learn and adapt over time, so that the query module 142 can produce improved query results. The query module 142 can receive feedback from query responses and the learning module 146 can update a machine learning model that the query module 142 can use to generate query results. Team member search results can improve over time, for example, as team members provide input indicating whether query results are relevant or helpful. The learning module 146, along with the NLP module 144, can analyze and interpret team member responses and team member follow-up requests, to determine whether a user found a result helpful. For example, the user may submit multiple queries in succession, and the NLP module 144 may determine that the queries are similar in meaning. The learning module 146 can determine that the earlier query results in the sequence were perhaps not as relevant as the user had wished. The learning module 146 can also determine that the later, refined queries were actually what the user initially intended, and the learning module 146 can update the machine learning model so as to better interpret future user requests.

The guided interaction module 141 can be used by the team to configure team processes so that the team members can be interactively guided through the team processes using the guided interaction module 141. Team tasks that are to be completed by multiple team members can be completed consistently, accurately, and easily, with interactive engagement, using the guided interaction module 141. A team member, such as a manager or other team member, can define a process, and other team members can execute the defined process.

The guided interaction module 141 can receive different types of inputs to define a team process. For example, manual inputs, such as written, typed, or spoken words can be provided that define steps of the process and any resources that may need to be accessed to complete the steps. As another example, the guided interaction module 141 can receive a pictorial description of the process, such as a flowchart or a formatted chart. The guided interaction module 141 can parse the provided inputs to determine process steps. Information about determined steps can be stored for the process.

When a team member requests to execute the team process, the steps of the process can be converted into conversational steps by the guided interaction module 141 that can be provided to the team chatbot 112 or the embedded team chatbot 116. For example, a team chatbot can, in response to receiving information from the guided interaction module 141, prompt the user to perform a first step. For some steps, the team chatbot can provide a link to a resource, such as a document, tool, system, or application that can be used to complete the step. The guided interaction module 141 can determine when and whether the team member completed a step. For some steps, the guided interaction module 141 can automatically determine if a step was completed (e.g., if a document was opened, if a particular application was launched, etc.). For other steps, the team chatbot can ask the user to inform the team chatbot when the task has been completed. Once the guided interaction module 141 has determined that a step has been completed, the guided interaction module 141 can provide information to the team chatbot so that the team chatbot can prompt the user to complete the next step. The team member, when performing the steps, may determine that some of the directions or resources are incorrect or out of date. For example, a link to a tool may need updating. The team member can provide feedback on inaccuracy and needed corrections, and the guided interaction module 141 can update the defined process, so that the process is correct for the next team member. As another example, a message can be automatically sent to the team member who created the team process, if the guided interaction module 141 can't automatically fix the process.

Various types of team processes can be defined and executed using the guided interaction module 141. For example, for an upcoming team meeting or event, certain authorizations or forms may need to be completed. The team manager can create a team process for team members to complete certain authorizations and forms, and define steps that describe the tasks and the needed resources. The team manager can inform the team (either in the team chatbot itself or in another team communication) that the guided interaction for the upcoming event is available in the team chatbot. Each team member can access the guided interaction for the upcoming event, to complete the defined steps.

As a particular example of a guided team process, the guided interaction module 141 can be used to define and execute an onboarding process for the team. An organization may already have a general onboarding process for new hires, but the general onboarding process may not cover specific steps needed for a new team member, including for a new team member who is not new to the company but has switched teams. A team-specific onboarding may be necessary for certain teams, with team-specific steps. Team-specific onboarding, when defined and implemented using the guided interaction module 141, can guide the user to request and receive certain authorizations, install or access certain tools, become registered for particular systems which the team uses, become aware of and access team resources, such as team project folders, and other steps.

As another example of a guided process, which can be part of team onboarding but may also be used, for example, when a team member receives an upgraded computing device, is a development environment setup process. The development environment setup process can be defined by a team lead, for example, and once a team member is guided through the development environment setup process using the team chatbot, the developer can be prepared for development work on the team. Development environment setup steps that the developer can be guided with can include installation and configuration of code editors, obtaining a SDK (Software Development Kit), configuring a database, obtaining certain authorizations, etc. As with other processes, if a developer discovers that, for example, a link to a SDK is out of date, the developer can respond to the guided interaction with a correction, and the guided interaction module 141 can automatically update the development environment setup guided interaction, so that the next developer who performs the process receives updated instructions.

As used in the present disclosure, the term “computer” is intended to encompass any suitable processing device. For example, although FIG. 1 illustrates a single team continuity platform 102, the system 100 can be implemented using two or more servers. Indeed, the team continuity platform 102 may be or include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the team continuity platform 102 and the team member device 104 may be adapted to execute any operating system, including Linux, UNIX, Windows, Mac OS®, Java™, Android™, iOS or any other suitable operating system. According to one implementation, the team continuity platform 102 may also include or be communicably coupled with an e-mail server, a Web server, a caching server, a streaming data server, and/or other suitable server.

Interfaces 150, 152, and 154 are used by the team member device 104, the team continuity platform 102, and the other system 105b, respectively, for communicating with other systems in a distributed environment—including within the system 100—connected to the network 106. Generally, the interfaces 150, 152, and 154 each comprise logic encoded in software and/or hardware in a suitable combination and operable to communicate with the network 106. More specifically, the interfaces 150, 152, and 154 may each comprise software supporting one or more communication protocols associated with communications such that the network 106 or interface's hardware is operable to communicate physical signals within and outside of the illustrated system 100.

The team continuity platform 102 includes one or more processors 156. Each processor 156 may be a central processing unit (CPU), a blade, an application specific integrated circuit (ASIC), a field-programmable gate array (FPGA), or another suitable component. Generally, each processor 156 executes instructions and manipulates data to perform the operations of the team continuity platform 102. Specifically, each processor 156 executes the functionality required to receive and respond to requests from the team member device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Python, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The team continuity platform 102 includes memory 158. In some implementations, the team continuity platform 102 includes multiple memories. The memory 158 may include any type of memory or database module and may take the form of volatile and/or non-volatile memory including, without limitation, magnetic media, optical media, random access memory (RAM), read-only memory (ROM), removable media, or any other suitable local or remote memory component. The memory 158 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the team continuity platform 102.

The team member device 104 may generally be any computing device operable to connect to or communicate with the team continuity platform 102 via the network 106 using a wireline or wireless connection. In general, the team member device 104 comprises an electronic computer device operable to receive, transmit, process, and store any appropriate data associated with the system 100 of FIG. 1. The team member device 104 can include one or more client applications, including the team chatbot 112 and the application 114. A client application is any type of application that allows the team member device 104 to request and view content on the team member device 104. In some implementations, a client application can use parameters, metadata, and other information received at launch to access a particular set of data from the team continuity platform 102. In some instances, a client application may be an agent or client-side version of the one or more enterprise applications running on an enterprise server (not shown).

The team member device 104 further includes one or more processors 160. Each processor 160 included in the team member device 104 may be a central processing unit (CPU), an application specific integrated circuit (ASIC), a field-programmable gate array (FPGA), or another suitable component. Generally, each processor 160 included in the team member device 104 executes instructions and manipulates data to perform the operations of the team member device 104. Specifically, each processor 160 included in the team member device 104 executes the functionality required to send requests to the team continuity platform 102 and to receive and process responses from the team continuity platform 102.

The team member device 104 is generally intended to encompass any client computing device such as a laptop/notebook computer, wireless data port, smart phone, personal data assistant (PDA), tablet computing device, one or more processors within these devices, or any other suitable processing device. For example, the team member device 104 may comprise a computer that includes an input device, such as a keypad, touch screen, or other device that can accept user information, and an output device that conveys information associated with the operation of the team continuity platform 102, or the team member device 104 itself, including digital data, visual information, or a GUI 162.

The GUI 162 of the team member device 104 interfaces with at least a portion of the system 100 for any suitable purpose, including generating a visual representation of the team chatbot 112 or the application 114. In particular, the GUI 162 may be used to view and navigate various Web pages, or other user interfaces. Generally, the GUI 162 provides the user with an efficient and user-friendly presentation of business data provided by or communicated within the system. The GUI 162 may comprise a plurality of customizable frames or views having interactive fields, pull-down lists, and buttons operated by the user. The GUI 162 contemplates any suitable graphical user interface, such as a combination of a generic web browser, intelligent engine, and command line interface (CLI) that processes information and efficiently presents the results to the user visually. Alternatively or additionally, the team member device 104 can include a voice recorder that can record voice commands and send voice commands to the team continuity platform 102.

Memory 164 included in the team member device 104 may include any memory or database module and may take the form of volatile or non-volatile memory including, without limitation, magnetic media, optical media, random access memory (RAM), read-only memory (ROM), removable media, or any other suitable local or remote memory component. The memory 164 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the team member device 104.

There may be any number of team member devices 104 associated with, or external to, the system 100. Additionally, there may also be one or more team member devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the team member device 104 is described in terms of being used by a single user, this disclosure contemplates that many users may use one computer, or that one user may use multiple computers.

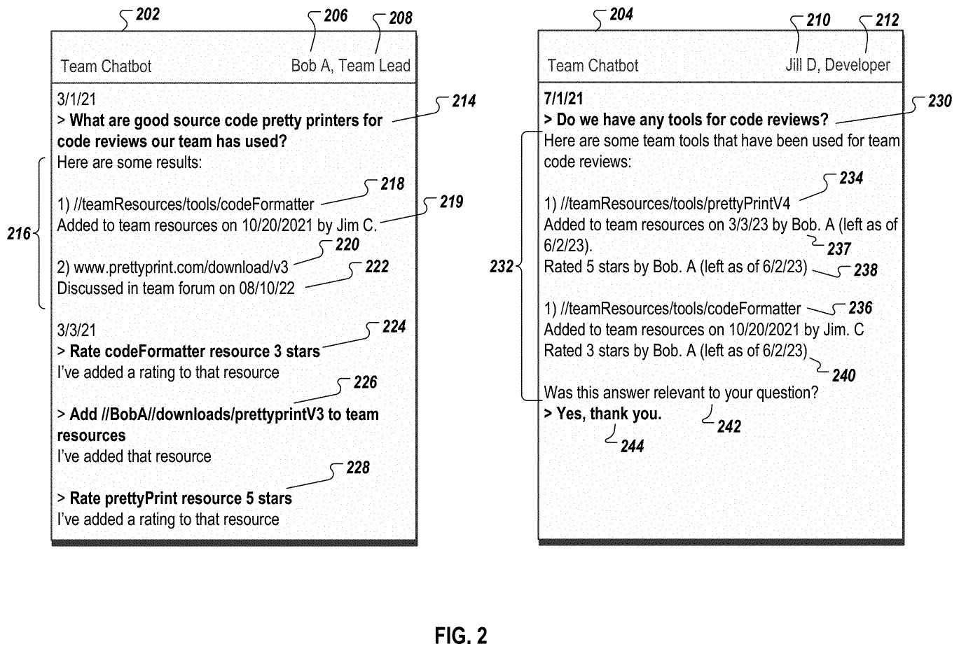

FIG. 2 illustrates example team chatbot user interfaces 202 and 204. The example team chatbot user interfaces 202 and 204 can correspond to the team chatbot 112 and/or the embedded team chatbot 116 described above with respect to FIG. 1. The team chatbot user interface 202 corresponds to a team member 206 named Bob A., who has a role 208 of team lead. The team chatbot user interface 204 corresponds to a team member 210 named Jill D., who has a role 212 of developer.

The team member 206 has submitted a query 214 to the team continuity platform (e.g., the team continuity platform 102). The query 214 can be a spoken or typed query, for example. The team member 206 is submitting the query 214 to the team continuity platform to determine whether the team continuity platform is aware of any source code “pretty printers” (e.g., for printing source code in a formatted fashion) for use in code reviews by the team.

A query module (e.g., the query module 142) can receive the query 214, and a NLP module (e.g., the NLP module 144) can analyze the query 214 to determine the meaning of the query 214. The query module can determine which content sources to query (e.g., the team quick links 130, the team tools and content repository 132, and/or external sources) to look for information to include in a query response. For example, the query module can generate a query response 216 for the query 214. The query response 216 includes a first resource link 218 that is a link to a specific “code formatter” tool in a specific sub folder in a team folder repository. A note 219 indicates that a team member Jim. C added the code formatter tool to the team repository on Oct. 20, 2021. The query response 216 also includes a second resource link 220 that is a link to an external resource available from an external website. A note 222 indicates that the external resource (e.g., a “pretty print” tool) was discussed on Aug. 10, 2022 in a team discussion forum.

The user 206 can use the first resource link 218 and/or the second resource link 220 to access the recommended resources specified in the query response 216. For example, the user 206 can select the first resource link 218 to launch the code formatter tool. As another example, the user 206 can select the second resource link 220 to download the recommended “pretty printer” tool from the external website.

The user 206 can provide feedback to the team continuity platform regarding the query response 216. For example, the user 206 has submitted a request 224 to rate the code formatter tool with a three star rating (e.g., out of five stars). The user has also submitted a request 226 to add a “pretty printer” tool (e.g., that the user 206 has downloaded from the external website) to the team repository. The user 206 has also submitted a request 228 to rate the “pretty printer” tool with a five star rating. The requests 224, 226, and 228 may indicate that the user 206 experimented with the recommended tools and found one tool (the “pretty printer” tool) preferable and also worthy of being added as a team resource rather than a resource only downloaded to just the machine of the user 206 or only remaining on the external website.

The feedback and ratings provided by the user 206 can be received by the query module, which can then adapt and learn to generate better future query responses. For example, the user 210, after the request 228 was submitted by the user 206, has submitted a query 230 to the team continuity platform to ask a question about tools for code reviews. The query module can generate a query response 232 for the query 230. The query response 232 includes a first resource link 234 and a second resource link 236. The first resource link 234 is a link to a fourth version of a “pretty printer” tool in a specific sub folder in the team folder repository. The second resource link 236 corresponds to the first resource link 218 (e.g., a link to the same code formatter tool). As an indication of the adaptation and learning of the query module, a link to the “pretty printer” tool is now shown as a top result, before a link for the code formatter tool, based on the ratings provided by the user 206 in the requests 224 and 228.

A note 237 indicates that the user 206 had previously added the “pretty printer” tool as a team resource. The note 237 also indicates that the user 206 has since left the team. Even though the user 206 has left the team, team content the user 206 has added, or given feedback on, can still be maintained by the team continuity platform. A note 238 documents the rating by the user 206 corresponding to the request 228 and a note 240 documents the rating by the user 206 corresponding to the request 224. The query response 232 also includes a feedback request 242 that asks the team member 210 if the query response 232 was relevant to the query 230. The user 210 has responded with a feedback response 244, confirming that the query response 232 is relevant to the query 230. The query module can receive the feedback response 244 and use the feedback response 244 to better learn how to respond to future requests.

As mentioned, the first resource link 234 is a link to a fourth version of the “pretty printer” tool. The user 206 had initially added, by submitting the request 226, a third version of the “pretty printer” tool to the team repository. The team continuity platform can perform processing to keep resources up to date. The team continuity platform can periodically query the external website www.prettyprint.com included in the second resource link 220, to determine whether a new version of the tool is available. The team continuity platform may have determined that a newer, fourth version of the tool was available and automatically downloaded the fourth version, to replace the third version of the tool in the team repository. The team member 210 therefore, can automatically access the newer fourth version, rather than the older third version.

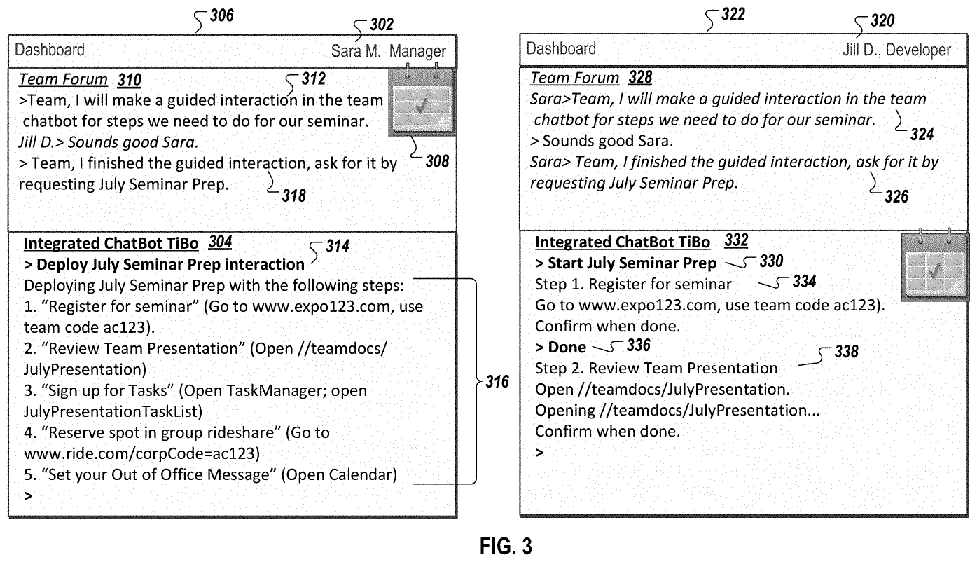

FIG. 3 illustrates embedded team chatbots. A team manager 302 named Sara M. is using an embedded team chatbot 304 that is integrated into a dashboard application 306. The dashboard application 306 includes other features, such as a calendar 308 and a team forum 310. The team manager 302 has posted a message 312 in the team forum 310 informing the team that the team manager will be using the team continuity platform to create a guided interaction for tasks team members should do to prepare for an upcoming seminar.

The team manager 302 has defined the seminar preparation guided process by using the embedded team chatbot 304 to interface with the team guided interaction module of the team continuity platform. As mentioned above, a guided interaction can be created by providing a description of steps and details regarding any needed or used resources, links, applications, systems, or other content. The team manager 302 has defined the steps for the seminar preparation process and has submitted a request 314 within the embedded team chatbot 304 to deploy the seminar preparation process as a guided interaction. The embedded team chatbot 304 displays a reply 316 that confirms the deployment and lists five steps that have been defined for the guided process. The steps include 1) navigating to an external seminar registration site and using a team registration code; 2) reviewing a team presentation document that is stored in a team project folder; 3) signing up for tasks for the seminar by launching a team document in a particular application; 4) reserving a spot in a group rideshare by navigating to an external site and providing a team code; and 5) launching a calendar application so as to set an out of office message.

The team manager 302 has posted a message 318 in the team forum 310 regarding availability of the guided process in the team chatbot. Although the team forum 310 is shown as separate from the embedded team chatbot 304, in some implementations, the team chatbot 304 can also be used for team discussion, as well as for individual interaction with the team continuity platform.

In the illustrated dashboard application 322, a team member 320 named Jill D. is using a dashboard application 322 and can view messages 324 and 326 from the team manager 302 (that correspond to the messages 312 and 318, respectively) in a team forum 328. In response to receiving the message 326, the team member 320 can submit a request 330 in an embedded team chatbot 332 to begin the seminar preparation guided interaction. The guided interaction module can use the embedded team chatbot 332 to display directions 334 for a first process step. The directions 334 prompt the user to inform the embedded team chatbot when the first step has been completed. As mentioned above, for some steps, the guided interaction module can automatically determine completion of a process step. The team member 320 has manually submitted a confirmation 336 regarding completion of the first step. In response to receiving the confirmation 336, the guided interaction module can use the embedded team chatbot 332 to display directions 338 for the second step. The guided interaction can continue until all of the steps are completed. Each of the other team members can also use the team continuity platform to complete the guided interaction. The guided interaction can be configured so that the team manager 302 is notified regarding completion progress (and/or lack of progress) of the guided interaction by members of the team. In some instances, the second step may be automatically determined to be complete once the team member 320 opens the documents, while in others, a manual confirmation may be required.

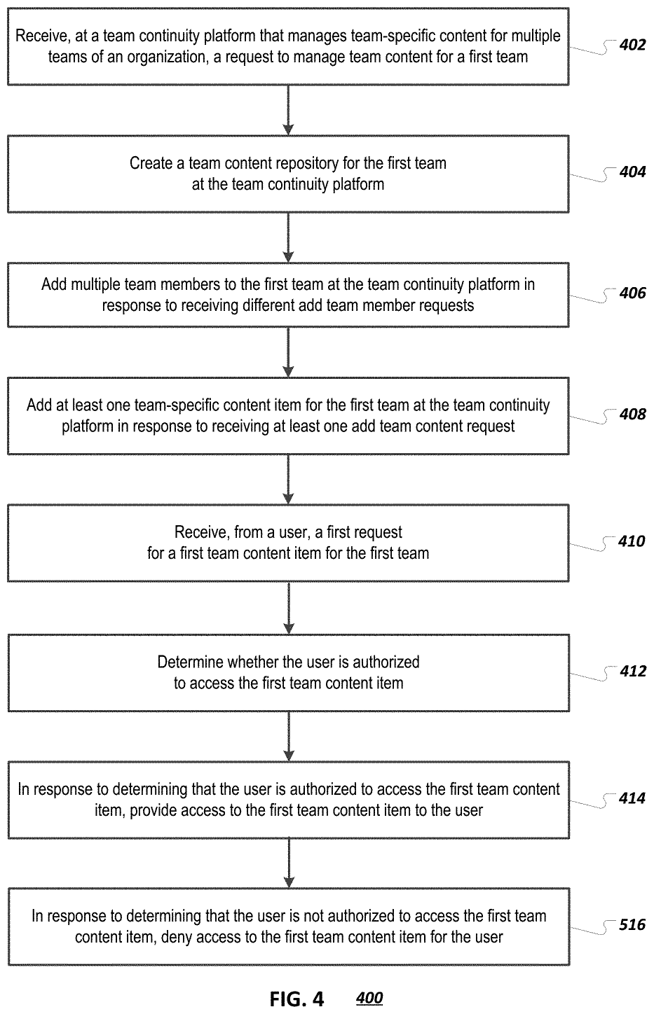

FIG. 4 is a flowchart of an example method for continuous management of team content and resources. It will be understood that method 400 and related methods may be performed, for example, by any suitable system, environment, software, and hardware, or a combination of systems, environments, software, and hardware, as appropriate. For example, one or more of a client, a server, or other computing device can be used to execute method 400 and related methods and obtain any data from the memory of a client, the server, or the other computing device. In some implementations, the method 400 and related methods are executed by one or more components of the system 100 described above with respect to FIG. 1. For example, the method 1000 and related methods can be executed by the team continuity platform 102 of FIG. 1.

At 402, a request to manage team content for a first team is revived at a team continuity platform that manages team-specific content for multiple teams of an organization. The request can be received using a conversational interface. The request can be processed using a conversational AI component.

At 404, a team content repository is created for the first team at the team continuity platform.

At 406, multiple team members are added to the first team at the team continuity platform in response to receiving different add team member requests. Each team member can be added to the first team, either when the team is first configured, or when a new team member joins the team. The add team member requests can be received using the conversational interface. The add team member requests can be processed using the conversational AI component.

At 408, at least one team-specific content item for the first team is added at the team continuity platform in response to receiving at least one add team content request. Types of team content are described below with respect to step 410. The add team content requests can be received using the conversational interface. The add team content requests can be processed using the conversational AI component.

The operations of 402, 404, 406, and 408 may be initial setup operations. Additionally, several of the operations can be performed at various times after the initial setup, such as allowing additional content and team members to be added to the team.

At 410, a first request for a first team content item for the first team is received from a user (e.g., using the conversational interface). The first team content item can be contact information for a non-team employee who interacts with the first team, a document used by the first team, a resource used by the first team, or a link to a document, resource, system, or application used by the first team. The document or other resource can be stored at an organizational system that is separate from the team continuity platform. The team continuity platform can maintain a copy of the document or other resource at the team continuity platform, and can provide the copy of the document or resource in response to the first request. The team continuity platform can retrieve the document or other resource from the organizational system in response to the first request. The first team content item can be a link to the document or resource stored at the organizational system and the team continuity platform can use the link to retrieve the document or other resource from the organizational system in response to the first request.

At 412, a determination is made as to whether the user is authorized to access the first team content item. Determining that the user is authorized to access the first team content item comprises determining that the user is a member of the first team who has sufficient privileges to access the first team content item.

At 414, access is provided to the first team content item in response to determining that the user is authorized to access the first team content item. The team continuity platform can create an instance of a virtual team assistant to handle requests for the first team, including the first request. The user can interact with the virtual team assistant using a conversational interface. The user can provide feedback for handling of the first request to the virtual team assistant and a machine learning component of the virtual team assistant can update a machine learning model to improve handling of future team content requests for the first team.

The team continuity platform can receive a description of a team process to be performed by members of the first team and can later receive a request to execute the team process for a first member of the first team. The virtual team assistant can guide the first member of the first team to execute steps of the first process.

The team continuity platform can initiate a team content update process that is configured to monitor team content status for the first team and retrieve updated team content in response to determining that team content for the first team is out of date. The team content update process can include detecting that the copy of the document stored at the team continuity platform is an older version of the document than a version of the document that is stored at the organizational system and retrieving the version of the document stored at the organizational system to update the copy of the document stored at the team continuity platform.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving, at a team continuity platform that manages team-specific content for multiple teams of an organization, a request to manage team content for a first team;
creating a team content repository for the first team at the team continuity platform;
adding multiple team members to the first team at the team continuity platform in response to receiving multiple respective add team member requests;
adding at least one team-specific content item for the first team at the team continuity platform in response to receiving at least one add team content request;
receiving, from a user, a first request for a first team content item for the first team;
determining whether the user is authorized to access the first team content item;
in response to determining that the user is authorized to access the first team content item, providing access to the first team content item to the user; and
in response to determining that the user is not authorized to access the first team content item, denying access to the first team content item for the user.

2. The computer-implemented method of claim 1, wherein determining that the user is authorized to access the first team content item comprises determining that the user is a member of the first team who has sufficient privileges to access the first team content item.

3. The computer-implemented method of claim 1, wherein the first team content item comprises contact information for a non-team employee who interacts with the first team.

4. The computer-implemented method of claim 1, wherein the first team content item comprises a document used by the first team.

5. The computer-implemented method of claim 4, wherein the document is stored at an organizational system that is separate from the team continuity platform.

6. The computer-implemented method of claim 5, wherein the team continuity platform maintains a copy of the document at the team continuity platform and provides the copy of the document in response to the first request.

7. The computer-implemented method of claim 5, wherein the team continuity platform retrieves the document from the organizational system in response to the first request.

8. The computer-implemented method of claim 5, further comprising initiating a team content update process that is configured to automatically monitor team content status at the organizational system for the first team and automatically retrieve updated team content from the organizational system in response to determining that team content for the first team is out of date.

9. The computer-implemented method of claim 8, wherein the team content update process includes:
automatically detecting that the copy of the document stored at the team continuity platform is an older version of the document than a version of the document that is stored at the organizational system; and
automatically retrieving the version of the document stored at the organizational system to update the copy of the document stored at the team continuity platform.

10. The computer-implemented method of claim 5, wherein the first team content item is a link to the document stored at the organizational system.

11. The computer-implemented method of claim 1, further comprising creating an instance of a virtual team assistant to handle requests for the first team, wherein the virtual team assistant receives the first request for the first team content item.

12. The computer-implemented method of claim 1, wherein the user interacts with the virtual team assistant using a conversational interface.

13. The computer-implemented method of claim 1, wherein the user provides feedback for handling of the first request to the virtual team assistant and a machine learning component of the virtual team assistant updates a machine learning model to improve handling of future team content requests for the first team.

14. The computer-implemented method of claim 1, further comprising receiving at the team continuity platform a description of a team process to be performed by members of the first team.

15. The computer-implemented method of claim 1, further comprising:
receiving a request to execute the team process for a first member of the first team;
guiding, by the virtual team assistant, the first member of the first team to execute steps of the first process.

16. A system comprising:
one or more computers; and
a computer-readable medium coupled to the one or more computers having instructions stored thereon which, when executed by the one or more computers, cause the one or more computers to perform operations comprising:
receiving, at a team continuity platform that manages team-specific content for multiple teams of an organization, a request to manage team content for a first team;
creating a team content repository for the first team at the team continuity platform;
adding multiple team members to the first team at the team continuity platform in response to receiving multiple respective add team member requests;
adding at least one team-specific content item for the first team at the team continuity platform in response to receiving at least one add team content request;
receiving, from a user, a first request for a first team content item for the first team;
determining whether the user is authorized to access the first team content item;
in response to determining that the user is authorized to access the first team content item, providing access to the first team content item to the user; and
in response to determining that the user is not authorized to access the first team content item, denying access to the first team content item for the user.

17. The system of claim 16, wherein determining that the user is authorized to access the first team content item comprises determining that the user is a member of the first team who has sufficient privileges to access the first team content item.

18. The system of claim 16, wherein the first team content item comprises contact information for a non-team employee who interacts with the first team.

19. A computer program product encoded on a non-transitory storage medium, the product comprising non-transitory, computer readable instructions for causing one or more processors to perform operations comprising:
receiving, at a team continuity platform that manages team-specific content for multiple teams of an organization, a request to manage team content for a first team;
creating a team content repository for the first team at the team continuity platform;
adding multiple team members to the first team at the team continuity platform in response to receiving multiple respective add team member requests;
adding at least one team-specific content item for the first team at the team continuity platform in response to receiving at least one add team content request;
receiving, from a user, a first request for a first team content item for the first team;
determining whether the user is authorized to access the first team content item; and
in response to determining that the user is authorized to access the first team content item, providing access to the first team content item to the user; and
in response to determining that the user is not authorized to access the first team content item, denying access to the first team content item for the user.

20. The computer program product of claim 19, wherein determining that the user is authorized to access the first team content item comprises determining that the user is a member of the first team who has sufficient privileges to access the first team content item.
